(19) United States
(12) Patent Application Publication
(10) Pub. No.: US 2010/0096293 A1
(43) Pub. Date: Apr. 22, 2010

(54) ELECTRONIC MEDICATION DISPENSING SYSTEM AND RELATED UTILITIES

(76) Inventor: Raanan Liebermann, North Haven, CT (US)

Correspondence Address: BACHMAN & LAPOINTE, P.C., 900 CHAPEL STREET, SUITE 1201, NEW HAVEN, CT, 06510, US

(21) Appl. No.: 12/603,711

(22) Filed: Oct. 22, 2009

Related U.S. Application Data
(60) Provisional application No. 61/107,377, filed on Oct. 22, 2008.

(51) Int. Cl. B65D 83/04; G08B 23/00; G08B 5/00; G08B 25/08; G06Q 30/00

(52) U.S. Cl. 206/534; 340/573.1; 340/691.1; 340/692; 705/14.23

(57) ABSTRACT

A system for electronic dispensing of medication and methods of increased exposure of users to such system is provided. Medication dispensing while in transit and related transit amenities is provided. Advertising on such devices and electronic coupon clipping and administration is also provided.

### CROSS REFERENCE TO RELATED APPLICATION(S)

This application claims the benefit of U.S. provisional patent application No. 61/107,377, filed Oct. 22, 2008, entitled “ELECTRONIC MEDICATION DISPENSING SYSTEM AND RELATED UTILITIES.”

### BACKGROUND

1. Field of the Invention

The present invention relates to a system for storing, enabling consumption and refilling of medications and relevant instructions, enabling control of dispensation time and type of medication, as well as a facility for recording and bookkeeping of said dispensations and an automatic request for reorder or issuing of new prescriptions. Said system is for medication consumption by at least one of humans and animals. The system also enables transmission and reception of messages between the user or user's agent and others, such as pharmacies and healthcare providers and receiving notification about medications and other information, such as about products and services in a variety of forms, including the form of advertising. The system further contains an independent electronic coupon “clipping”, transmitting and billing facility that is extendable as an independent utility for uses beyond the medical dispensation system.

2. Prior Art

People, especially those who are aging, exhibit memory problems or more specifically recall problems, such as “where did I leave my keys” or “what was I going to say a moment ago before I was interrupted”. Interruption could also be by another thought, deed or a person. Recall problems could affect health of a person when it comes to taking medication, where it could be important not only to take certain medication on time but also not to take it more than once thinking it was not already taken, or forgetting that one took a medication that would have ill effect when combined with another to be taken and get into the blood stream, or forgetting being allergic to a particular medicine or that one consumed alcohol prior to taking medication, when prohibitive to do so, to mention just some such problems. Similar problems can occur when administering medications to animals.

Various mechanical housing containers for medicine are available that help the user or user's agent remember if the medication was already taken, enabling to guard against inadvertent multiple consumption of medication and visual confirmation that medication needs to be taken. Such devices need to be filled at a certain period of time, such as daily or weekly with the appropriate medications that are normally pills of one sort or another.

### SUMMARY OF THE INVENTION

In accordance with this instant disclosure, there is described a system for electronic medication dispensation (EMDS) and reminder to users, or their agents, as a solution to the problems mentioned hereinabove and can be programmed and/or constructed in a number of ways.

In accordance with this instant disclosure there is described a system for programming and/or constructing of an apparatus for at least one of a substance and a type of medication, whose quantity, and dispensation time can be provided and for which conflicting medications can be blocked for the person who or animal that needs to take the medication(s)including recording of time(s) taken, whether food is being or been consumed, and elapsed time before or after any food consumption for medication(s) to be administered. Said system is for use by a person, on his or her behalf, or on behalf of an animal needing the medication, or his/her agent; for use by a family member or caretaker, a nurse, a pharmacy, a hospital, or a physician's office to mention some of the possibilities. Such programming, whether mechanical or electronic, can be done manually, such as by inserting a programming note, such as a punched strip of paper, done electronically or downloaded from the Internet to name a few possibilities. Said system is not limited to a singular apparatus and can function independently, or in conjunction with reminder notes and/or activation by such an item or device as a mobile electronic device or a laptop computer.

Other details of the medication dispensation system, advertising and electronic coupon clipping systems of the present invention, as well as other objects and advantages attendant thereto, are set forth in the following detailed description and the accompanying drawings, where like reference numerals depict like elements.

### BRIEF DESCRIPTION OF THE DRAWING(S)

FIG. 1 illustrates an embodiment of the electronic medication dispensing base unit and one extension from a possible number of extensions to the base unit.

FIG. 2 illustrates the essence of the process managing the medication dispensing and communications related thereto.

FIG. 3 illustrates the electronic coupon clipping and administration aspect of the EMDS.

FIG. 4 illustrates the general process of electronic coupon clipping and administration.

### DETAILED DESCRIPTION OF THE PREFERRED EMBODIMENT(S)

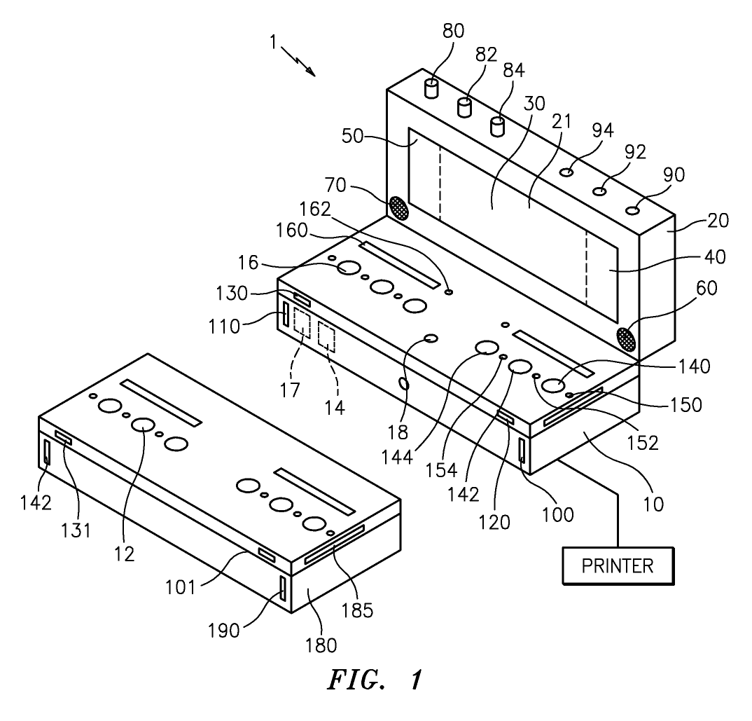

Referring now to FIG. 1, the pill dispensing system in a preferred embodiment is made of a base unit (10) containing the minimal elements needed for its function and the ability to hook up to additional segments or extension units (180), each unit (180) containing at least one container or receptacle (12) for a substance or a medication, and which may rely on the base unit for its functioning.

Next to each container in the base unit (10) and the extension unit (180), there may be at least one light emitting device, such as a light emitting diode (LED), that can light up in at least one of any one of multiple colors. The role of each of the color LEDs is to alert the user or his/her agent, either to take a substance or a medication or that taking the substance or medication is prohibited at that time. For example, a green LED may come up when it is time to take medication, whereas a red LED may appear if medication was already taken or if the medication cannot be taken due to the fact that a medication previously taken is contraindicated to take with the specific medication in the container next to the red LED. If the user ignores the green light clue to take the specific medication on time, the green light LED may turn into a pulsating or flashing green light for capturing the attention of the user.

Further, an audio signal, such as an audible alarm, may also be included in the alert. The audio signal can be at least one of a buzz, a musical, or other tone(s), or a verbal message.

Yet, in another step of alert, useful for such users as elderly persons who are being monitored by a nursing facility or a family member, the system can issue an alert by tone, voice message or text message sent to the nursing facility or a family member that said medication taking time has past without its being dispensed. Such message may be sent by the system via a communication device (14), such as a modem or a telephone line, in the base unit (10) to the pre-designated recipient device, such as a nursing station monitoring system, a telephone, mobile unit, computer or laptop computer. Alerts are also useful for ambulatory persons or animals, where staff of a facility may be reminded of dispensing medication and times for administering same, as well as for other sundry activities, such as taking the patient outside for a walk or just to be in the fresh air, getting them a canned drink from a dispensing unit, etc.

Yet, in another safeguarding measure beyond LED lights, such as the red light appearing when either the medication was already taken or would be in conflict with another medication taken, a lid (16) over a receptacle or container may be programmed to not allow it to be opened for extraction of the medication, until such time as the green light or its equivalent indicates allowance. Likewise, the lid (16) over the container may be enabled for opening when the green light or its equivalent indicates time to take medication or allowance. Various other measures and combinations of alerts and safeguarding mechanisms are possible.

Medications, supplements and other over the counter substances that do not require medical prescription by a physician but could nonetheless potentially cause harm if consumed together with either medication prescribed by a physician or with another over the counter substance not requiring such prescription, need to be considered so that said potential harm may be prevented by the medical dispensing unit's “External Safeguard” facility.

Said External Safeguard facility monitors not only the potential effect of taking said substance(s) together with a specific medication but also taking them within a time period of potential effect and accordingly may alert the person contemplating taking any such substance before taking it.

Likewise, a relevant agent for a person or animal may be alerted to the potential consequence(s) should any of said substances be provided. Further, the dispensing unit may contain also non-prescription substances against which any external potential substance for consumption may be checked in addition to other medications or substances housed in the dispensing unit.

Any person skilled in the art can construct an input facility for such substance related to the medications in the dispensing unit, such as by reading a barcode, a name or entry by a person, leading to consulting appropriate database of substances not recommended for taking with the medication or substance already dispensed or about to be dispensed by the unit. Said database can be on board of the dispensing unit or at a remote location that may be reached by any communication method known in the art and available to or enabled by the dispensing unit.

A person may download from at least one of the dispensing unit and its traveling portion to a mobile communication device any information designated for at least one of a travel and safety check, so that substance(s) and medicine interactions for a specific person can be checked right from said mobile communication device by providing information about the contemplated new substance or medicine.

Further, a general program that encompasses medications and substances, irrespective of any potential user may reside in a database and allow consulting by any party utilizing at least one of a computer and a mobile communication device, communicating with said database.

Mixing alcohol with certain medications, such as acetaminophen (TYLENOL®) could create a problematic situation for the person and the system described herein can warn and issue an alert in such cases or even function as a guard and/or gatekeeper in such events.

Various parties, such as a pharmacy or a physician's office could leave a message on the base unit (10) by such means as voice or text, picture, illustration or video. For example, a reminder for the user, such as to take their monthly BONIVA® medication on a particular day (the “BONIVA® Day”), as is currently customary by the company. Further, they could trigger a constant or flashing light next to a specific medication compartment if this is the nature of the message, or use an LED light from the general group that is not associated with any specific compartment housing medication in the system, especially when the medication, such as BONIVA® medication is not housed in the unit because it is taken only once a month.

Further, in the situation where a container can be made to lock down, an external party (e.g., authorized Federal authority or the maker of a certain medication) can, in addition to the light signal, also block access to the medication if for example, an emergency discovery that all users are in danger when taking certain medications.

In general, the system of the present invention can have a display that automatically posts notices, such as when the time has come to take a particular medication or alternatively a warning that could be augmented with sound, graphics, picture, video and/or light that could be either constant or flashing in a chosen color, such as red and in a predetermined frequency when a person contemplates taking two incompatible medications.

Further, the system display panel (20) can show messages, such as from a pharmacy notifying that medication is ready for pick up, from a physician that it is time to make another appointment or confirmation of an appointment time, or any other messages, whether personal or general, such as in the form of advertising a particular medication or any unrelated product, or via connectivity to social networks, such as FACEBOOK or LINKEDIN, or an application on a mobile communication device. Said messages, such as appointment reminder from a physician may be confirmed as received by the user of the dispensing unit who may press any appropriate button or key for such purpose.

Further such said warning can also appear when the system user (human or animal) intends to take or receive medication to which he or she is allergic or his/her agent is so alerted when wishing to dispense certain such medications.

Further, since each system may be personalized for the use of a particular individual, each of the receptacles or containers housing a specific medication can be programmed to count the number of medications, such as pills left after each consumption, whether it is by counting the number of times the lid is opened or if automatically being dispensed by the system that notes the original amount started with when the medication was registered with it for use.

Thus, in a fully automated system, each said pill receptacle or container would contain only the number of pills proper to take and release to user only the appropriate amount at the appropriate time. Such time can have some latitude of minutes before and after as sanctioned by the physician or pharmacy or alternatively set to factory default. If artificial intelligence is used for such timing, then fuzzy logic may be used for approximate time, while neural network(s) may be used for the exact time. Further, the system may be provided with an appropriate cutting mechanism to slice any appropriate portion of a pill to the portion authorized for intake before dispensing it, while keeping the marked residual for future intake. As before, artificial intelligence, such as fuzzy logic may be employed to determine and safeguard that only a portion of the pill within appropriate boundaries is released for the receiving party. Various sound and light alerts, including textual message(s) may accompany at least one of a cutting and release of a portion pill.

For communication with the pharmacy, physician or any other external source, the system may have any communication facility (14) known in the art within the base unit (10), such as via the Internet, dialing direct or automatically, by wireless or computer technology, such as WiFi.

Information for dispensing medication and timing can be received in various ways. Customer or customer's agent can receive the needed information or said information may be transmitted via the canisters with medications received from the pharmacy through inscription or code on the canisters, such as a barcode or alphanumeric characters or via direct transmission from the pharmacy or physician's office to the medical dispensing unit of the patient. The patient or patient's agent may also receive said information during an office visit to a healthcare facility or pharmacy that may be provided on an electronic card that may be inserted into the medical dispensing unit where it may be processed so that said information will be transferred to the database of the medical dispensing unit for handling the relevant dispensing of medications.

The system unit would optimally have a button or key (18) to dial automatically for an emergency, such as “911” in the U.S., so that it becomes a “one-stop-handling” for medical and health issues for the person who uses it. Further, said unit may become a comprehensive electronic medical chest where the user could get immediate access to such parties as his or her various physicians, dentists, veterinarians for a pet, or a hospital, whether it is for questions, emergency or routine situation.

As has been described herein, said base unit (10) has reception capabilities from external sources, such as pharmacy, physicians, or messages unrelated to the specific medications in said unit. Said unit (10) can therefore receive advertising sent or aired from a center dedicated to sales and/or service of said units or third party licensed to do so. Further, said advertising may also be embedded in said unit (10) from time to time to show up on the display (20) of said unit (10) and may also utilize speakers (60, 70) when appropriate, with timed advertising material that may be singular in nature or repetitive.

In particular, said unit (10) could be equipped to receive advertising either sent directly to it, or by having its display (20) connected to a TV reception mechanism fed in any form known in the art or from said center. Reception of said advertising can also come from a direct link to a TV station. It can be further arranged that all said units (10) possessed by users could receive their advertising messages on a certain dedicated frequency, so that all such said units (10) receive simultaneously the same messages.

Yet, said base unit (10) can be connected to a web site using any suitable technology known in the art and receive the messages to be displayed from said web site. Sound in such forms as music or speech in any suitable language can accompany the messages.

One of the characteristics of said medication dispensing system is that a pharmacy can embed group of advertising in said base unit (10) upon providing or refilling medications that are later shown to the users. Any one advertising spot from said embedded group can show up randomly on the display (20) and can appear at any time desired, such as at specific time intervals, or either appear all day or be timed to when medication need to be dispensed. The pharmacy may also transmit by wire, wireless or Internet, said advertising material to arrive at any particular EMDS unit (10), to all such units (10) it has access to or selectively to certain units (10) based on their medication history without violating confidential information of the receiving parties and said medications used by them. The advertising material may contain a coupon code and an item of interest such as a product or service for discount or coupon.

The containers or receptacles holding the various medications would preferably have covers (16) that need system permission to be opened, and such opening could be either automatic by the system, such when the time has come to take medication, by depressing a button, or by other means, such as touch for such persons as those with arthritis who have difficulty to exert pressure on a key. Alternatively, the covers (16) to the containers and their closing and release mechanism may all be part of the EMDS unit.

For medications that require refrigeration said unit may either have a mini-refrigerated segment (17) or an add-on unit that can be housed in a refrigerator and when the alert for taking the medication appears, said refrigerated unit can be taken out of the refrigerator and hooked up to or inserted within said base unit (10) for activation in the standard manner.

As has already been disclosed, a user of said medication dispensing unit (10) can activate release of medication by pressing a key or alternatively by touch that is useful for such individuals who suffer form arthritis. Activation by touch may also be extended to the display (20) of said base unit (10). Activation for release of medication may either be permitted or prohibited by the system, depending on the type of medications and their instructions, with a proper mechanism that may allow the user, his or her agent or a third party, such as a pharmacy or physician to override the system prohibition, by local functions or by remote control.

Thus, touching a certain location on the screen of the display (20) will activate a specific function in said unit or on the display unit itself. Such activation of area on the display unit may also cause alphanumeric key delineation, such as a standard phone pad or a QWERTY keyboard and thereafter each key would respond to touch appropriately.

Touching again the location that activated the on-screen input mechanism may cause the said input display mechanism to be temporarily removed from the screen until reactivated. Namely, there is provided an on-screen toggle switch.

Further capability of said base unit (10) is the ability to measure diabetic profile situation for people who need to do that at least once a day. Instead of walking with the unit or searching for it, it may be either an integral part of said base unit or attached to it through one of the ports available in the base unit, such as a USB port.

The Electronic Medication Dispensing System (EMDS) unit (1) can come in at least one version that is stationary and can be placed on any counter. Said unit (1) can also come as a smaller handheld unit that can be carried around and be appropriate for such situations as travel. Any communications of said units (1) with such parties as pharmacy and physician can be accomplished by hooking up to a landline phone connectivity, such as RJ-11, utilizing wireless connectivity or Internet communication, either directly or via a mobile communication device.

Such Internet communication can also be through a dedicated web site, such as related to the company providing said units or service to it acting as a go-between a registered customer and the parties that customer's unit is trying to reach.

Further, when traveling, said unit (1) can notify its user where to find an appropriate pharmacy for refill and said user can also automatically be referred to an appropriate health provider in the region when needed. Such facilities become available upon the insertion of location into the unit, such as a zip code, town and state or utilizing a GPS unit that may either be an integral part of said unit or an external GPS system that can be hooked up to it.

Said notification to customer, indicating where to find a pharmacy can be extended to notification that may be on demand for other desired locations for entities, such as a physician, dentist, a veterinarian, a hospital (including one for animals), a restaurant, business facility and /or a relevant parking facility close to any of said entities.

Further, where appropriate, said customer may reserve a place with any of said entities or said related parking facility that may be done in at least one of a phone call, an electronic fashion and automatically. Upon selection of any outfit by a customer or customer's agent a confirmation code may be issued to said customer or customer's agent, as well as directions to reach said outfits and/or the relevant parking facilities. Said confirmation code may be any code used in the art, such as at least one of a word, a name, a barcode or an alphanumeric figure that may also be received electronically by customer's device with electronic reception facility. Said code may be presented upon the customer or customer's agent arriving at the facility for which the reservation code was issued and may be matched verbally or electronically for clearing entrance or ascertaining positional priority.

Said locating and reserving place in any of said facilities or their relevant parking facility may also enable securing a parking spot by payment via at least one of a credit or debit card and an FCT account belonging to customer or customer's agent.

Said reserving of a parking place in a parking facility for a customer or customer's agent on his or her way to a pharmacy or any of said entities, for which customer or customer's agent may pay ahead of time to secure said parking place includes also parking meters in any jurisdiction where appropriate. Further, Customer or customer's agent may search electronically from a computing device or a relevant mobile communication device if said parking facility has vacancies or is full. Said search may also be conducted automatically by the electronic device utilized when locating an appropriate parking facility. If said parking facility is already full, customer or customer's agent may be directed to the next available parking facility closest to said indicated desired location and enable securing a parking spot in said next closest parking facility, if vacant spots exist. If no parking spots are available, redirection to the next closest parking facility takes place. Said securing spot may be done electronically via at least one of a credit or debit card or an FCT facility. Customer may receive directions to said parking spot and authorization code to ascertain secured spot and acceptance by said parking facility. Said at least one of search, finding, securing, and payment for said outfits and/or parking spot may be processed via at least one of a dedicated electronic device, a mobile communication device, such as a cell phone or a GPS navigation unit that either has said capabilities or may interface to them. Further, walking distance between any parking facility and the desired entity may be provided in at least one of a length units, such as feet and a time unit, such as minutes required to arrive at said entity when walking at an average human pace.

Said notification to customer or customer's agent about a pharmacy, physician or any other desired outfit in said desired location, may take into account that customer may not be familiar with said pharmacy, physician or any other desired facility. Therefore, information may be provided to customer about a public grading of said entity. Said public grading may be based on statistical result of visitors to said outfit who provided grading of said outfit on an established scale, such as from 1 to 5 where 5 is the best. Such grading is not limited to the medical dispensing units and can be extended across other users who may provide their grading of an outfit after visiting it that may be for the benefit of other users who may not use the medical dispensing units. Such provision of opinion and consulting it may be done via any form and device that is know in the art, such as written material, computers, mobile communication units or GPS navigation units equipped for it or that may interface to enabling facility. Further, relating assessment and grading to customers may be in at least one of an alphanumeric form, an illustration, picture, video or Morse code.

Any of said entities may each have a radio frequency identification (RFID) instrument, such as a tab affixed to a surface at said entity that may contain code for electronic guide to said entity. Said RFID may contain code for at least one of an entity's name, address, directions to it, identification of parking location in its vicinity, and discount coupons for parking payments at said parking facilities that may be contingent on validation that a visit to the facility occurred.

Once a local pharmacy is determined, authorization for providing medication or refill is transmitted from the original pharmacy or physician to the locally determined pharmacy and the procedure is the same as in the domicile of the unit user. Alternatively, authorizations, such as resulting from prescriptions may be housed in a central database that is accessible by any pharmacy desiring information or physician requiring information regarding a patient, whether human or animal and operational directly or indirectly cross-pharmacies and cross pharmacy-chains. Such authorization in said central database may be upgraded to a new status once medication has been dispensed by the local pharmacy. Similarly, patient information in said central database may be upgraded by any local physician attending to said patient. Such central database may have built-in redundancy, as well as alternate location(s) in order to ascertain that data is never lost and is available at all times.

The travel unit may have all kinds of security measures, enabling security at airports and seaports to validate the content and the authenticity of the prescriptions. Said travel unit may also be locked by security personnel after inspection and be unlocked only after disembarkation by any form known in the art, such as an authorized flight attendant or by transmission of code, such as from the aircraft or vessel, affecting all similar said units. Such transmitted code may have a built-in time delay in order to ascertain that the unit becomes available and can be opened only when in safe distance from the airplane and airport or public transportation, to name a few places of public concern. Accommodations for time discrepancies may take place when such time delay interferes with crucial timing of dispensing medication to patient.

The EMDS may also have an internal computing mechanism, such as by a computer chip programmed to dispense a report of a sum total of expense for medications for the particular year used for the purpose of income tax filing that can be printed or transmitted to any desired location. Alternatively, the unit (10) may have an internal computer or computer chip programmed to request the pharmacies and physicians to dispatch such expense information to the unit holder or any designated third party. Similar reports may be provided by and to healthcare facilities, such as hospitals as related to patients treated, medication amounts and cost.

While there could be color-coded EMDS units to distinguish among family members, some units may account for situations where at least one member utilizing the EMDS is blind. For example, EMDS units may have protruded (elevated) numbers on them or the ability to arrange for one out of several numbers to come to surface and protrude out of the surface of said units. Said protruded numbers may be in any suitable form, such as numerals or in Braille.

Further, for those individuals who are blind, the EMDS units may have next to each container, either instead of or in addition to the LED lights, other means for marking the medication, as well as other means, such as a voice prompt, for alerting the blind person to take the medication, or deny it. Said markings for persons who are both deaf and blind may be by vibrations, utilizing a code, such as Morse code or language elements, utilizing Touch Language developed by R. Liebermann.

The EMDS can be filled up with new or refilled medications by a variety of methods or persons, such as the user or user's agent, a family member, a physician's office or the pharmacy. The pharmacy can dispense medications directly into the EMDS unit (1) or a portion of it that is carried to the pharmacy and may provide the information for the electronic monitoring and dispensing mechanism of the EMDS, such as dispensation instructions. The pharmacy may provide the medication in the traditional manner of containers and affix to each container an appropriate ID that gets transferred to the electronic operation of the EMDS unit. Such ID may be in the form of a barcode or other code that can be electronically read by the EMDS unit and may also carry information about such items as dispensing timing and quantity. Alternatively, the relevant instructions and information can be transmitted to the EMDS unit by the pharmacy utilizing any communications means known in the art.

The pharmacy may have in its possession a reciprocal unit to the EMDS unit (1) that may enable direct insertion of medications and programming information into the EMDS unit or disengaged parts of it that are carried to said pharmacy.

If desired, each of the removable receptacles or containers in the multi-container EMDS apparatus may have a somewhat different but standard physical shape not allowing mixing them up with regards to the individual fixed housing for such containers in the apparatus.

The medications, such as pills may be poured into the containers from above and each container may have a releasing mechanism that is timed to release only the proper amount of needed medication, such as pills at the appropriate time and thereafter make such medication unavailable to the user.

Turning now to FIG. 1, there is shown a unit (1) having a base unit (10) and one of the extension units (180). We start with the base unit (10) and what it illustrates. The front panel has hooks (100) and (110) that would hook the base unit (10) to the extension unit (180) via hooks or receptacles (not shown) in the back of the unit (180), which hooks or receptacles mate with the hooks (100) and (110). Electronic ports (120, 130) for communicating information between the base unit (10) and the extension unit (180) may be located on the upper front panel of the base unit (10). Similar electronic communication ports exist in the backside of extension unit (180), which ports are similar to their frontal counterparts (101) and (131) on the front panel of the extension unit (180). Receptacles (144), (142) and (140) for medications are shown on the right hand side of the base unit (10), with their respective LED lights (154), (152), and (150). The receptacles and LED lights are all mirrored with similar receptacles and LED lights on the left hand side of the base unit (10). Each of the receptacles (140, 142 and 144) may be removable. Further, each receptacle may have a lid or closure (16). Each lid (16) may be programmed to open at certain times. A receptacle (160) on the left hand side of the base unit (10) may be for such medications as ointments in a tube with its LED alert (162) and may be mirrored by an additional receptacle and LED on the right hand side of the base unit (10).

The display part (20) of the base unit (10) is shown in FIG. 1 and its parts are described as follows. Speakers (70) and (60) enable voice alerts and explanations to the user, as well as other spoken words, tones, and sounds including music. The center part (30) of the display is where messages related to any medications to be taken may be shown. The center part (30) of the display (20) may also be used to display advertising material. A touch keyboard may appear in the portion (30) when activated by a displayed toggle touch switch in that position. The left side (50) of the display screen portion is where messages from a pharmacy may appear, such as an indication that refills are ready since the amount of medication in a respective receptacle has been reduced to the number given, or a message from a physician may appear. The right hand side portion (40) of the display screen is where coupon-clipping and related merchandise and discount information may be displayed. There are a number of LED lights (90), (92) and (94) on the top of the panel. There are also depressible keys (80), (82) and (84) on top of the display panel that can activate actions or signal information from a user to the EMDS unit and potential subsequent communication out of the EMDS unit, such as to a pharmacy, physician, or merchandise related facility.

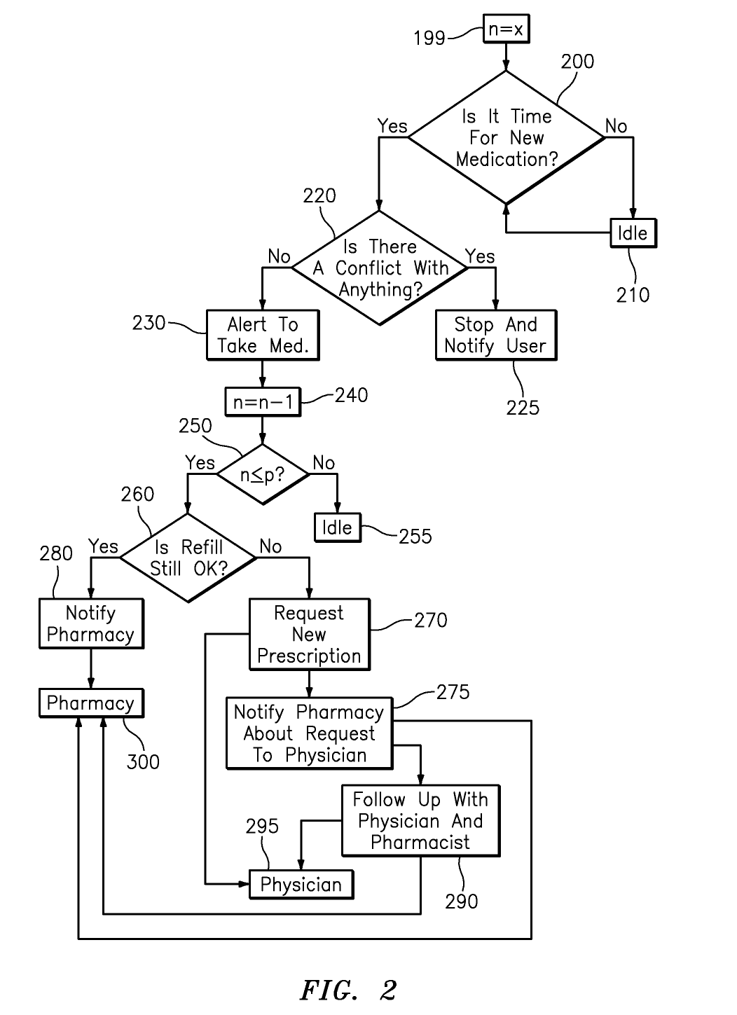

FIG. 2 illustrates the basic processing of the EMDS. In step (199), the number of doses of a particular medication is stored. In step (200), it is inquired whether it is time to take the medication. If the answer is negative, the system idles in step (210) and keeps checking again in step (200) according to a series of default time settings. If the answer is affirmative, then the system proceeds to check in step (220) if the particular medication to be dispensed is in conflict with any other medication already taken. If the answer is affirmative, the dispensing of the medication is blocked in step (225) and the user is notified appropriately. If the answer to the query in step (220) is negative, the system proceeds to notify user to take the medication in step (230). In step (240), the system deducts by one the amount of the medication unit number established in step (199) where “X” indicates that number, keeping score of how many more units are still available. In step (250), it is queried if the number of the medication doses or units has reached a threshold “P” where a refill request needs to be dispatched. If the query result is negative the system idles in step (255) to when the next medication needs to be taken, otherwise it proceeds to check in step (260) if a refill is appropriate, such as if refills are left under the prescription and a year has not lapsed from the date when the prescription was issued. If the query result is affirmative, then the pharmacy in (300) is notified in step (280). However, if the answer is negative, both the physician in (295) and pharmacy (300) are notified in step (275). Subsequent to the notifications, the system confirms in step (290) that a new prescription had been forwarded by the physician (295) to the pharmacy (300).

The display (20) and its screen (21) is an important portion of the EMDS unit (1) for relating information between the consumer and the pharmacy and physician. To increase exposure time to the Electronic Medication Dispensing system (EMDS) unit and thereby maximizing seeing and/or hearing the alert signal for taking medication, the base unit (10) may include various ancillary elements to capture the attention of the user. Such ancillary elements may be as follows:

There are games known in the art that persons play on computers or mobile communication devices, such as chess, and the EMDS system may incorporate them as well as the ability to partake in various related activities, such as self or one-one-one games or competitions. The games may be displayed on screen (21). Games and any other applications known in the art, such as those available on mobile units may be downloaded to the base unit (1) and engaged by the user or user's agent.

Another activity known in the art is printing coupons provided on a web site and there are several such provisions.

However, a more unique activity that is not known in the art is the electronic clipping of such coupons with added electronic activity as described below that will ultimately generate more activity with said Electronic Medication Dispensing System (EMDS) unit (1) as follows:

The utility of advertising for the purpose of capturing added attention to the EMDS unit by its users has been presented and disclosed. With the added service of electronic coupon clipping and administration, it is now possible to advance a new art where such clipping can also be ordered if they are not yet available and where the users may be notified upon availability and such coupons may automatically be credited to said users' coupon account.

Namely, any user watching an advertising and seeing an item of interest can press a key on any suitable device known in the art, such as a TV dedicated remote control, a generalized remote control that may have built-in hardware and/or software functions for it, a mobile communication device such as a wireless phone, the base unit (10) of the EMDS, or touch the appropriate spot on the screen of said TV or said EMDS unit, thereby indicating interest in receiving a coupon for such merchandise. The system (1), via its internal computer, any suitable search engine, and external communication devices, may thereupon search for the availability of any such coupons that have not yet expired and transmit and alert the user to such effect. Said process of search and notification may also operate on other devices, such as computers or mobile communication devices. Moreover, the system using the aforementioned tools may also check if said user also has a coupon account and if one exists then credit said account with said coupon value. If such account does not yet exist, the system may place the electronic coupon in buffer and create a temporary coupon account for said customer. Thereafter the customer may be prodded to accept such account that thereupon becomes a permanent coupon account identified with said user. Certain additional information might be solicited from said user to complete the utility of said coupon account unless they are already available in the system, such as said user's telephone number and FCT account identification. FCT account particulars appear in a previously granted patent to the applicant (U.S. Pat. No. 7,287,009), which is incorporated by reference herein as to the particulars of an FCT account.

Further, the electronic coupon clipping and administration, where one can indicate interest when a commercial is aired or a product shown on a media is not limited to the EMDS unit disclosed in this application and has validity also to more general markets known in the art, such as TV advertising, advertising in shopping malls, when an emergency alert is posted on display units, electronic billboards or on wireless mobile units, such as cell phones or even on a sundry of electronic games.

Thus, the Electronic Coupon Clipping and Administration can function also beyond the EMDS unit (1) and can be an independent system, a device or be incorporated into other devices, such as computers, laptop computers or mobile communication devices, such as phones. To this end, the essentials of such system and product when utilized independently of the EMDS unit are discussed below.

The electronic clipping could also include the name of a selling outfit, an address and a telephone number. Further, such outfits could advertise on billboards or on their own outfit location, such as a building or other buildings and include a wireless (RF) transmitter that transmits a coupon code and information about a product or service to which the coupon or a discount applies that can be captured by an appropriate device having RF receiving capabilities, such as a mobile telephone unit. A person passing by said advertising and transmission facility, whether by foot or vehicle, may capture said code and information for later use. Said capturing may be done automatically for every item so advertised, or coupon provided or activated at will for any particular item by the user of said mobile device. Further, a capturing unit for such RF data can be in a vehicle and become activated and capture said data by voice activation of person(s) in the vehicle or by pressing a specific button or key. Further, same type of capturing may be utilized upon radio transmission where the person in the vehicle causes said coupon and/or merchandise information to be captured for future use.

In a preferred embodiment, the display screen such as screen (21) may be divided into four portions: (1) a first portion may be the screen management portion that has such items as the toggle touch key for the touch keyboard or electronic coupon clipping activation and processing; (2) a second portion, and possibly the largest and central portion, may be dedicated to information regarding medications, such as medications that need to be taken and their alerts, those that were already taken or medications that may be conflicting with medications already taken. This portion of the screen may also be useful for special alerts, such as explaining to the user why a certain medicine is denied, where for example it was already taken or is in conflict with something already taken; (3) a third portion may be one of the remaining possibly smaller portions of the display screen (21) and may be devoted to messages from pharmacies and physician related to refills being ready for pick up or new prescriptions and similar communications. Alternatively, all said functions may be called from a summary list on the side of (21) and allow the majority of the screen in (21) to display current related information, since some users, and especially older ones may benefit from larger font letters and display area. It may also be used for airing advertisements; and (4) a fourth and last portion of the display screen may be the other possibly smaller portion and may be devoted to ancillary usage of the EMDS unit (1), such as playing an online electronic game, such as chess, or for various advertising and specifically may be used for electronic coupon clipping and administration.

The display unit (20) may also contain a button or key, whether physical or a touch screen “button” or “key” so that when pressing or touching it respectively, it will cause the information on the display screen (21) to stay longer displayed or may be made to return back upon desire, so that persons who become forgetful or are slow readers may be able to either complete the reading or go back to it and see it. Alternatively, it could remain posted in front of their eyes. All that may be achieved by such means as placing information in a buffer and displaying the desired material for the time required. Such innovation is not limited to the EMDS system and can be utilized for other situations, such as material showing up on a computer screen, where someone else besides the reader controls its speed of flow, or a TV screen during a TV broadcast, or a mobile unit showing displayed content. This is the text and image version of our innovation of slowing down speech (c.f. published U.S. Patent Application No. 20080002814, claims 118-121, which are herein incorporated by reference).

The coupon-clipping portion on the display screen (21) may have a touch button, preferably in color, where touching it will automatically activate the “acquisition mode” for the specific coupon related to the advertised spot product of interest. Alternatively, said “acquisition mode” can be exercised for products of interest to the viewer even if no commercial is presented for a particular product. Said acquisition mode may also be activated in response to any particular product shown or specific coupons offered from a web site shown on any display screen, such as TV, mobile communication device, computer or EMDS. There may also be a real button or key to press next to the display panel or in another location for those preferring not to use the touch button or unable to do so, such as blind persons who may also need to utilize Braille for it and rely on voice to realize what is offered or displayed.

At any particular point, such as when leaving the display and where the user had indicated an interest in the product/service or coupon before exiting, such as when leaving the EDMS unit, a summary of said items of interest or coupons may be provided. Such summary can be a printed list if a printer is associated with the device or can be enabled by connecting to it. Alternatively, an electronic equivalent of said list can be created when an electronic device is available for such purpose, such as a special device dedicated for such purposes that may also be mounted on a memory stick (the so called “memory on a key”), a laptop computer, a mobile communication device, such as a telephone unit or the EMDS unit. Such list as well as coupons when available may also be downloaded to a personal account of a person or entity, either on a dedicated web site for such purposes, or any form known in the art and capable to house such data, such as a mobile communication device, a computer or an EMDS unit.

Said information may also be dispatched at such time or future appropriate time to outfit(s) from where such items would be procured by or for the user who expressed the interest. Thereupon, such coupon value could be redeemed by any person presenting it at cashing out at any such particular outfit, either the paper with the (possibly coded) list containing at least one of the items selected or by matching appropriate electronic codes between the cashing outfit and the person carrying the electronic device with the information, or enabling connection to where said information resides. Said person may also relegate purchasing interest and automated coupon redeeming to another agent that may be a trained pet, such as a dog that may be directed to go to the outfit and perform said activities.

Alternatively, even without said transmission to the outfits, it may be sufficient to print said list or embed said electronic code in said electronic device(s) for redeeming coupon value when cashing out at said outfits. Said outfits may make specific or general arrangements with their agents to release appropriate codes to the public via the media selected, such as the EMDS unit, TV broadcast, computer, mobile communication device or dedicated functioning of a web site.

Further, said printed list of at least one item or its said electronic equivalent may also have the option to present content of said list to at least one of a list of outfits with the coupon redeeming capability, and combine items from one or more of said outfits for ease of use by said user.

Generating said printed list or said electronic code equivalent may also be accomplished with other electronic display units besides the EMDS, such as a TV, a computer, or mobile communication device. Some of the options are: The TV emits codes that can be captured by said electronic devices; codes are available on websites related to TV broadcasting stations; or said electronic devices can capture the codes from the TV and automatically log those for which the user has indicated an interest. The codes from said TV broadcast do not necessarily have to be commercial codes during advertising. When a person views any particular presentation on at least one of a TV, a computer, an EMDS unit or mobile communication device and likes a specific article shown, if proper accommodations have been made, the user may indicate an interest and the equivalent discounted code, if appropriate, may be logged into said electronic device used by the user. If no such provision of coupons is available, the system may either notify the maker of such item or collect information about such item in a dedicated database in order to be provided to either makers of such items or other interested parties. Said provision of information may contain the number of viewers expressing interest, their location and other relevant statistical information. Said makers of said item or said interested parties may then consider provision of such coupons to at least one of the general public or those expressing interest that may automatically receive said coupons in any form known in the art or provided under this invention. Said makers or interested parties may have a commercial interest and financial incentive to obtain said statistical and customer information, such as by purchasing same.

Any would be customer may enter into any suitable system handling coupons and/or discounts, such as an EMDS, a dedicated web site, dedicated segment of a web site, a suitably equipped mobile communication device, such as a mobile phone, laptop or specific device for such purpose, a request for specific item(s). Said would be customer would subsequently be alerted whenever said item goes on sale and may be advised what outfit would carry said item at discount and/or honoring a coupon. Since all such activities can take place at the EMDS, it could provide more exposure to people using the system, thereby contributing to heightened alert to see information related to their medications. Thus, a customer may create a shopping list and the system may flag out items for which coupons are available for said customer, or may recommend that coupons exist and said customer may receive such coupons upon certain action taken by said customer. Alternatively said coupons may be downloaded to account of said customer for utilization. Said system may also indicate specific stores where such coupons may be honored. Further, irrespective of said relevant coupon, the system may indicate to said customers, what stores offer said items on the list at discount.

When no discount code is available for an item, or alternatively when a person creates a shopping list for a current or future utilization and an item of interest is not available for discount, the user may have the option to have the device used by the user send a notification to the company making the item or to outfits handling distribution or sales of such items showing an interest in said item. Upon such items becoming available for discount, such as by a coupon, said sending user may automatically receive notice of coupon availability and appropriate coupon value may then be available in the device used by the user or any other destination indicated by user. Said notifications may be transacted through a central facility that may have in its database information related to customers and their interests, manufacturers and items manufactured, distribution channels and sellers, including updated lists of discounts and coupons. Any relevant said user's account may be credited with such discount or coupon information to be available for redeeming at any appropriate selling facility.

At least one of a manufacturer, distribution outfits, selling outfits, the system where customers database is housed and other relevant parties may receive statistical information about the number of people looking to buy certain articles at any particular time and in any particular location and such advice may prompt them to issue buying incentives, such as electronic coupons or discounts, so as to attract buyers who looked for such articles and who may obtain a second wave coupon notification to their system. Said statistical information that does not reveal individual identity may be generated at such locations as a dedicated center, dedicated operations of web sites or in other suitable place or form and may be fed by information received from such devices as the EMDS, lap tops, mobile communication or display units, electronic canes or their equivalent equipped with procedures as disclosed herein or dedicated electronic units for coupons and discounts redeeming. Said database housing facility may also contract with manufacturing and/or selling facilities to poll customers in the database regarding current interest of an article for which customers expressed interest before, or other articles that are either related or not directly related to said articles. Connectivity through social network facilities, such as FACEBOOK may also be a viable option for would be customers requesting coupons and coupon providers alike. Further, interest in item(s) and coupon requests may also be obtained via search engines such as GOGGLE that display information. Said search engines, may provide coupon request capability under license from the holder of intellectual property rights to the coupon clipping innovation, its agent or assign to both articles advertised by their sponsors, as well as for items appearing in information material presented as a result of the search request. Said items of information material, prompting coupon request by users is another form of presentation on TV where the observer of the program indicates an item of interest in the program, a coupon or discount interest to be transmitted to the maker(s) of said article(s). Operating under a search engine, such as GOGGLE may be more encompassing, immediate and efficient as the whole process may be automated as a “one-stop-shopping” under our design.

Said communications between users who express interest in items and the manufacturing, distributing or selling outfits do not need be direct and can be conducted through an intermediary agent, such as a center or website that dedicates whole or part of its operation for such purposes. Said center or web site may be said database facility discussed before. Further, a user can insert a memory device such as a memory on a stick into an EMDS, laptop computer, or any other electronic device and while conducting searches or indicating interests, the electronic device may receive and may send the appropriate information. Further, any communication device, such as a mobile phone or electronic cane (the eCane) may partake in such communications, whether by direct connections or by wireless communication, such as RF, IR or WiFi. Any and all such discounts may be associated with an electronic financial transaction system, such as the Fast Cash Transactions (FCT) system.

In general a user may create a list of articles he or she wants to buy and enter their zip code, unless it is already in the system that searches for coupons or other discounts for those articles. If said articles are found as suitable for discount, the system may indicate where coupons redeeming or discount is available and may proceed to provide the user with a list of at least one of a (1) outfits, such as stores in said entered zip code region, indicating, such as by a character at the end or beginning of each item available for discount; namely, by adding a character such as “@” at the beginning or end of said articles; or (2) by indicating stores next to said articles. Alternatively, both said (1) and (2) may be made available to user. Such list may also be part of an itemized sales list where products may be grouped under common denominator, such as produce, dairy and meat. Alternatively, stores may opt to have individualized store template for customers with an aisle indication and/or store map for ease of shopping and item location and may allow for it to be presented on customer's electronic device used, that may be incorporated on said electronic device for ease of shopping. Said template may also include items on sales or for which coupons are available and that were not on original customer's list. Further, graphic or voice indication(s), including vibrations with code such as Morse code may guide customers at any particular store to the appropriate aisle and location for desired item(s), whether they are discounted, having a relevant coupon arrangements for said desired item(s), or none at all.

Said templates provided by the store or any other entity, such as the said database facility having such individual store information, a center for coupons and discounts processing, may have other features making the shopping party navigate during purchasing with added comfort. Such features could include maintaining a list of what was bought by said shopping party, removing it from the intended active purchase list and storing it in an archive, including day and/or price paid if desired. Also once in cart, the item could stay on the list in a different font or color such as red, whereas before it had a different color, such as green and only after passing the final cashing out process is removed into the archive. The total amount of money expensed may be shown to said shopping party during any phase of purchasing and may also be calculated to show its effect on the budget of said shopping party, enabling making adjustments on the spot, such as whether to forego an item, purchase it or double on the acquisition.

If a built-in scanner is available on the device used by said shopping party or can be attached to one, or alternatively the store's scanner is used, said device, such as a suitably equipped mobile communication or display device, may be able to read the price from a label or the scanner or receiving such transmitted information from it. Alternatively, the mobile device may be able to read the price from the tag next to items displayed, whether by numerals or barcode and utilize same for said calculations.

When said user cashes out at any of said outfits, it is sufficient to either present a list, activate an electronic device that allows for the appropriate discounts or utilize an FCT account or a credit or debit card that has the capabilities of providing said discounts. Said discounts may be provided directly by the credit or debit approving facility or via a link to a dedicated center, such as said database facility that tallies up appropriate discounts, or received such from the cashing outfit and adjusts the final pay appropriately. Appropriate electronic handshakes among the various participating processing centers are transparent to the user and may be caused to occur at the cashing station.

Said occurrence at cashing stations may be done before the actual cashing out event. For example, it may occur before arriving at the store while the user is at another place such as the user's place of residence or place of work or before the user is at the cashing stations while still in the store.

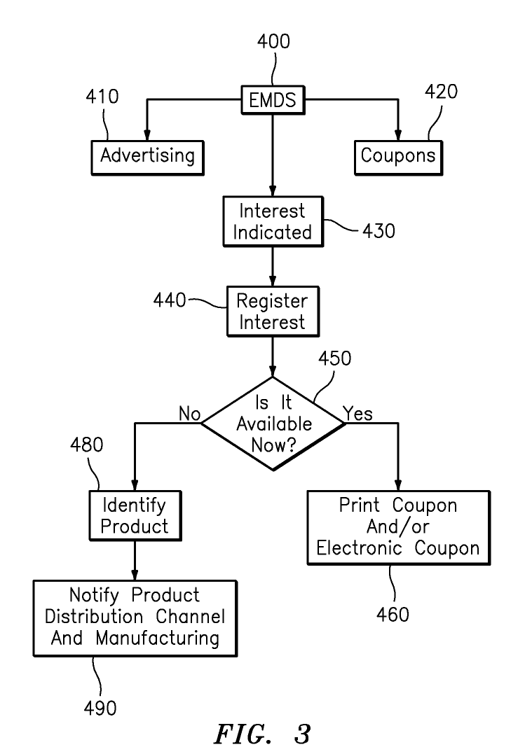

Turning now to FIG. 3, the EMDS unit (1) is illustrated in its relationship to the electronic coupon clipping and administration. Advertising in step (410) and coupon information in step (420) are fed to the display (20) in the EMDS in step (400) as instructed by its default settings. Any interest by the user is indicated in step (430) and registered in step (440). In step (450), it is queried if a coupon is available at the moment and if affirmative a printed or electronic coupon is generated in step (460). If a coupon is not available then the product is identified in step (480) and a notification to at least one of the product manufacturers, distribution channels and sellers are issued in step (490).

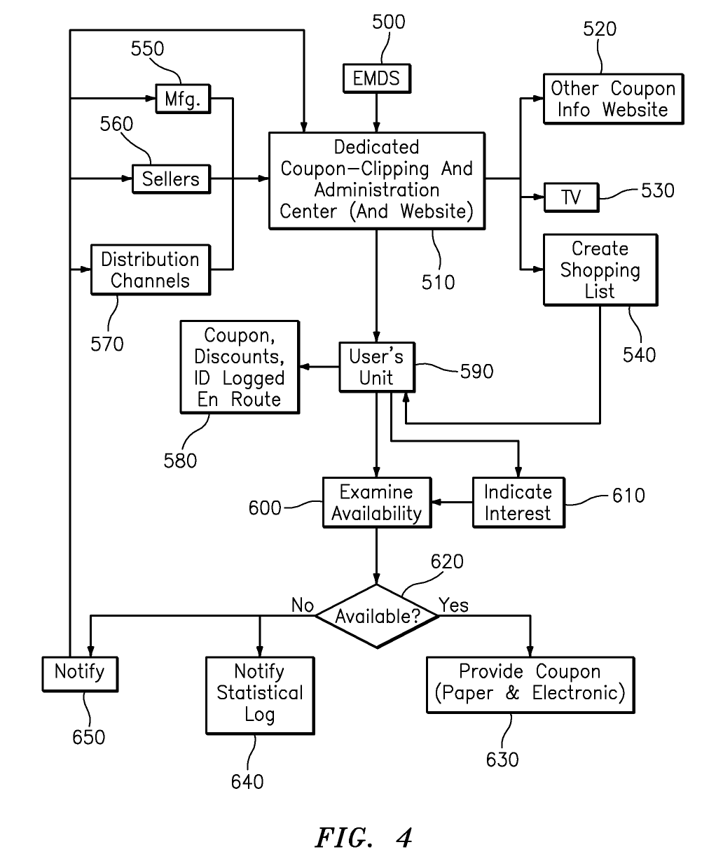

FIG. 4 illustrates one embodiment of the general functions of the electronic coupon clipping and administration. A dedicated center for coupon clipping and administration in step (510) receives information from a device, such as the EMDS unit in step (500), from the sell side of the manufacturers in step (550), from sellers in step (560), from distribution channels in step (570), from other coupon information web sites in step (520), from TV stations or search engines in step (530) and from shopping list creating systems in step (540). The user's unit in step (590) receives the information from the center (510), from shopping list creating system in step (540) and coupons, discounts and identification information retrieved by the unit while passing next to an RF emitter of such information to the public in step (580). Availability of coupons and discounts is examined in step (600) on information received from the user's unit in step (590) and indication of interest in step (610). Availability is checked out in step (620). If coupons and discounts are available, coupons are provided in step (630) in at least one of paper and electronic form. If coupons and/or discounts are not available, interest information is sent to the statistical log in step (640) and notifications are issued in step (650) to the manufacturers in step (550), sellers in step (560), and Distribution channels in step (570).

In a simpler, watered-down version of the preferred embodiment of the EMDS, the user or his or her agent may control some of the safety mechanisms of the EMDS, such as by turning any container or receptacle (140, 142, 144) with medications downward on a pivotal hinge (not shown) after medication had been dispensed from it. Likewise, the system turns containers back to an upward position when in a readiness state for the start of a new round of dispensing medication without confusion for current needed dispensation, such as when starting a new day or the required elapsed time has been reached. Alternatively, the EMDS unit may automatically cause such pivoting in the allowable and block it in the non-allowable state based on its embedded information and/or instructions.

As can be seen from the foregoing description, electronic medication dispensing system and electronic coupon clipping and administration and entity location and navigation to it and/or its parking facility for use to handle safe medication usage by people and animals and utilizing such and other devices to improve their shopping along the way with paying more attention to their medication dispensing units that can also carry advertising have been provided. While the present invention has been described in the context of specific embodiments thereof, other alternatives, modifications, and variations may become apparent to those skilled in the art having read the foregoing description. Accordingly, it is intended to embrace those alternatives, modifications, and variations.

What is claimed is:

1. A dispensing system comprising:
a base unit;
said base unit having a plurality of receptacles for holding one or more of at least one of a substance or and a medication; and
said base unit having means for providing information.

2. The system of claim 1 where said means for providing information is a light emitting device associated with each of the receptacles for indicating the status of whether a particular medication in each of said receptacles had been taken or needs to be taken and whether one of said medications can not be taken.

3. The system of claim 1, further comprising:
an extension unit having at least one receptacle for holding additional medication and at least one information providing means.

4. The system of claim 3, wherein the information providing means is a light emitting device associated therewith; and wherein the system has
means for attaching the extension unit to said base unit.

5. The system of claim 4, wherein said attaching means comprises at least one hook on said base unit for connecting said base unit to said extension unit.

6. The system of claim 4, further comprising electronic means for communicating information between the base unit and the extension unit.

7. The system of claim 1, wherein said base unit has at least one speaker for enabling sound alerts and voice explanations to a user.

8. The system of claim 1, wherein said base unit has a display with a first portion for showing messages related to medications to be taken.

9. The system of claim 8, wherein the display has a second portion for displaying information about available coupons and discount information.

10. The system of claim 8, wherein said base unit has a plurality of depressible keys on a frame of the display for activating actions and signaling information for a user.

11. The system of claim 8, wherein said display unit has an additional portion with a toggle touch key for a touch keyboard or for electronic coupon clipping activation and processing.

12. The system of claim 11, wherein said additional portion has a touch button for activating a coupon acquisition mode.

13. The system of claim 8, wherein said display unit has an additional portion for displaying messages from at least one of a hospital, pharmacies and physicians, or commercial outfits.

14. The system of claim 8, wherein said display unit has an additional portion for displaying on-line games.

15. The system of claim 1, further comprising a printer for printing at least one of a coupon and a summary of items of interest to a user.

16. The system of claim 1, further comprising means for turning a container of said medication downward when the medication has been dispensed and for turning said container upwards when the medication is to be dispensed.

17. The system according to claim 1, wherein said base unit has means for recording at least one of the time a medication was taken, whether food has been consumed, and an elapsed time before or after any food consumption.

18. The system according to claim 1, wherein said base unit has means for programming dispensation of said medications according to a predetermined schedule.

19. The system according to claim 2, wherein said light emitting devices are capable of pulsating or flashing if a medication is not taken at a proper time.

20. The system according to claim 1, further comprising an alarm system for alerting users that time has past for taking a medication.

21. The system according to claim 1, further comprising means for alerting a person at a remote location that a medication has not been taken.

22. The system according to claim 1, further comprising a closure associated with at least one of said receptacles.

23. The system according to claim 1, further comprising means for receiving reminders about said medications and displaying said reminders.

24. The system according to claim 1, further comprising a communication system for communication via at least one of the Internet, a telephone line, and wireless communication.

25. The system according to claim 1, further comprising a refrigeration segment for handling medications that require refrigeration.

26. The system according to claim 1, wherein each said receptacle has a releasing mechanism which is timed to release only a proper dosage of a medication.

27. A process for dispensing at least one of a substance and medication and information comprising:
providing a unit for dispensing at least one of a substance and a medication;
determining a time to take at least one of said substance and said medication; and
proceeding to dispense at least one of said medication and said substance with said unit at said determined time.

28. The process according to claim 27, where said unit performs checking whether at least one of said substance and said medication is in conflict with another at least one substance and medication already taken; and at least one of alerting user or user's agent to said conflict and blocking dispensation of said medication if there is a conflict with at least one of said another substance and said another medication.

29. The process of claim 28, further comprising notifying a user of said blocking.

30. The process according to claim 27, further comprising:
determining a number of available doses of said medication in said unit after said dispensation;
determining whether a refill threshold has been reached; and
dispatching a refill request if said threshold has been reached.

31. The process according to claim 27, further comprising forwarding a communication to at least one of a physician and a pharmacy if a prescription for said medication has expired.

32. The process according to claim 27, further comprising searching for availability of coupons and alerting the user to said available coupons.

33. The process according to claim 32, further comprising storing said available coupons in a buffer.

34. The process according to claim 32, further comprising crediting a coupon value to a coupon account associated with said user.

35. The process according to claim 27, further comprising feeding advertising and information to at least one of a speaker and a display in said unit.

36. The process according to claim 27, further comprising generating a coupon for a user to use.

37. A process for electronically clipping and administering coupons comprising the steps of:
locating at least one of an advertisement containing a coupon code and an item of interest of at least one of a product and service for discount or coupon;
transmitting a signal containing at least one of said item of interest and said coupon code;
capturing said signal containing at least one of said coupon code and said item of interest;
creating at least one of a list of captured coupons and a list of said at least one item of interest; and
storing said at least one said lists.

38. The process of claim 37, wherein at least one of said coupon and said item of interest is provided by presentation of a search engine.

39. The process of claim 37, wherein said capturing step comprises capturing said signal with at least one of a computer and a mobile device.

40. The process of claim 38, wherein said capturing step comprises capturing said signal with at least one of a computer and a mobile device.

41. The process of claim 37, wherein said capturing step comprises activating a capture device by one of a voice activated device and a depressable or touchable activation device.

42. The process of claim 38, wherein said capturing step comprises activating a capture device by one of a voice activated device and a depressable or touchable activation device.

43. The process of claim 37, further comprising displaying said at least one of informational material and advertisement on a display screen and activating at least one of a process and touching a portion of said display screen to capture at least one of said item of interest and said coupon code.

44. The process of claim 38, further comprising displaying said at least one of informational material and advertisement on a display screen and activating at least one of a process and touching a portion of said display screen to capture at least one of said item of interest and said coupon code.

45. The process of claim 37, further comprising providing a user with one of a printed list of said stored coupons and at least one coupon.

46. The process of claim 37, further comprising downloading said list to an account associated with a user.

47. The process of claim 37, further comprising redeeming at least one coupon on said list.

48. The process of claim 37, wherein said capturing step comprises providing an electronic medication dispensing unit and displaying said advertisement on a display screen associated with said unit; and said creating step comprises storing said coupon codes on a memory associated with said unit.

49. The process of claim 37, further comprising sending interest information to at least one of a coupon provider if a coupon for a particular product or service is not available and at least one of a producer and provider of said item of interest.

50. The process of claim 38, further comprising sending interest information to at least one of a coupon provider if a coupon for a particular product or service is not available and at least one of a producer and provider of said item of interest.
